(19) United States
(12) Patent Application Publication
(10) Pub. No.: US 2020/0117716 A1
(43) Pub. Date: Apr. 16, 2020

(54) METHODS FOR INTERPRETING AND EXTRACTING INFORMATION CONVEYED THROUGH VISUAL COMMUNICATIONS FROM ONE OR MORE VISUAL COMMUNICATION UNIT(S) INTO SPOKEN AND/OR WRITTEN AND/OR MACHINE LANGUAGE

(71) Applicant: Farimehr Schlake, Great Falls, VA (US)

(72) Inventor: Farimehr Schlake, Great Falls, VA (US)

(21) Appl. No.: 16/159,357

(22) Filed: Oct. 12, 2018

(51) Int. Cl. G06F 17/28; H04L 12/58; G06K 9/46

(52) U.S. Cl. CPC G06F 17/2863; G06F 17/289; G06K 9/46; H04L 51/10; G06F 17/2881

(57) ABSTRACT

The method for interpreting and extracting by visual communications conveyed information from visual communication unit(s) into spoken and/or written and/or machine language. This is done manually, and/or automatically, and/or autonomously, and/or driven by using, and/or through algorithms, scientific theories, concepts, methods and modalities, software, and/or hardware, and/or machine, or a combination of, interpreting, extracting and translating the conveyed information in the visual element(s), picture(s), geometric object(s), painting(s), drawing(s), video(s), movie(s), clip(s), art(s), animation(s), or a combination of, into spoken and/or written and/or machine language. Then, communicating this interpreted information through the communication channel(s), tool(s), format(s), and medium(s) of choice. The visual communication unit(s) and/or the information to be conveyed may be in lieu of or in conjunction with spoken and/or written language, sign language, Braille language, bar code, or any machine language, any scripting language, alphabets, numbers, symbols, words, sentences, voice, sound, music, any audibles or any combination of.

### TECHNICAL FIELD

Certain embodiments of the present disclosure generally relate to communications, visual communications, digital communication, telecommunications, instant messaging, messaging, computer and scientific, and Information Technology.

### BACKGROUND

There is a trend of visual communications, conveying information visually in communications, using visual element(s), picture(s), geometric object(s), painting(s), drawing(s), video(s), movie(s), clip(s), art(s), animation(s), and or a combination of. After receiving these visual communication unit(s) on the receiving end, and/or while in possession of one or more, the conveyed information may need to be interpreted, extracted and translated into written and/or spoken and/or machine language.

In addition, digital and Instant Messaging (IM), texting, and emails follow the same pattern. Many times, it is preferred to translate the visual communication used through these into audio messages depending on the situation and the preference of the user.

Our increasing mobile phone usage adds up to this need. The mobile phone use also has introduced a new hazard, while operating attention needing devices, such as texting while driving. Having another tool of communications during these situations is imperative.

Time has become a commodity in our daily lives. The speed and timing of the communication is increasingly of importance. In many situations, this can be cut short, since just one quick status update suffices, if we had the right communication tool, which could take care of this communication automatically and/or autonomously generating, creating and interpreting the to be conveyed information into written and/or spoken and/or machine language.

Both speed and ease of communication are of paramount importance in emergency situations, where there is no time for certain methods of communications.

Furthermore, people with special needs, developmentally disabled or people with acquired disabilities and regenerative and/or brain damaging diseases generally convey their information better and easier through visual communications and for some, this is the only viable way of communications. On the receiving side, there may be a need to interpret, extract and translate these visual clues into written and/or spoken and/or machine language.

Rapid advances in science and technology pave the way and put tremendous demands on convenience, speed, autonomy and automatic communications. The use of algorithms, scientific theories, concepts, methods and modalities, software and/or hardware and/or machine, or a combination of, to automatically and/or autonomously interpret, extract and translate the visual communication unit(s) into written and/or spoken and/or machine language is imperative. This will contribute to the diversity of choice, speed and ease of communication. It may further result to enhanced transfer of information.

Automatic and/or Autonomous machine-driven communication need to be flexible and capable of interpreting and translating visual communications and extracting the conveyed information for use in machines, Application-to-Application(A2A), Application-to-People (A2P), People-to-Application (P2A), and/or device to device communications.

Continuing the visual communication trend, blind people will be able to communicate visually as well. Once they receive their visual communication unit(s), it can be interpreted for them automatically and/or autonomously into written and/or spoken and/or machine language.

### SUMMARY OF DISCLOSURE

Certain embodiments of this disclosure provide a method generally including interpreting and extracting by visual communications conveyed information from visual communication unit(s) into spoken and/or written and/or machine language. This is done by interpreting, extracting and translating the information conveyed in the visual element(s), picture(s), geometric object(s), painting(s), drawing(s), video(s), movie(s), clip(s), art(s), animation(s), or a combination of, in visual communication unit(s), into spoken and/or written and/or machine language. Then, communicating the interpreted information through the communication channel(s), tool(s), format(s), and medium/media of choice.

Certain embodiments of this disclosure provide a method generally including the visual communication unit(s) and/or the information to be conveyed may be in lieu of or in conjunction with spoken and/or written language, sign language, Braille language, bar code, or any machine language, any scripting language, alphabets, numbers, symbols, words, sentences, voice, sound, music, any audibles or any combination of.

Certain embodiments of this disclosure provide a method generally including communicating through the communication channel(s), tool(s), format(s), and medium/media of choice, such as email, instant messaging, texting, facetime, mobile, cellular, satellite, landline, cable, phone, computers, networks, any form of communications, Artificial Intelligence and cyber tools, optical communications, or else (these are not an exhaustive list of available communication channels, tools and media).

Certain embodiments of this disclosure provide a method generally including interpreting, extracting and translating the conveyed information manually and/or by and/or within computers, phones, any form of communication device, gadgets, wearable technologies, watches, glasses, sensors, actuators, processors, microprocessors, toys, vehicles, any devices and hardware, any software, appliances, any structures, tools, buildings, monitors, keyboards, mice, any parts of a system, human bodies, organic structures, inorganic structures, (please note, this list is not an exhaustive list of possible tools, structures, and applications).

Certain embodiments of this disclosure provide a method generally including generating, creating, using and/or re-using of the interpreted information, using spoken and/or written language, sign language, Braille language, bar code, or any machine language, any scripting language, alphabets, numbers, symbols, words, sentences, voice, sound, music, any audibles or any combination of, and still may contain visual element(s), picture(s), geometric object(s), painting(s), drawing(s), video(s), movie(s), clip(s), art(s), animation(s), or a combination of.

Certain embodiments of this disclosure provide a method generally including interpreting, extracting and translating of the conveyed information, manually, and/or autonomously, and/or automatically, and/or driven by, using, and/or through algorithms, scientific theories, concepts, methods and modalities, software and/or hardware and/or machine, or a combination of, and/or by, and/or within computers, phones, any form of communication device, gadgets, wearable technologies, watches, glasses, sensors, actuators, processors, microprocessors, toys, vehicles, any devices and hardware, any software, appliances, any structures, tools, buildings, monitors, keyboards, mice, any parts of a system, human bodies, organic structures, inorganic structures, (please note, this list is not an exhaustive list of possible tools, structures, and applications).

Certain embodiments of this disclosure provide a method generally including generating, creating, using and/or re-using of the interpreted information are done autonomously, and/or automatically, and/or driven by using and/or through algorithms, scientific theories, concepts, methods and modalities, software, and/or hardware, and/or machine, or a combination of, using spoken and/or written language, sign language, Braille language, bar code, or any machine language, any scripting language, alphabets, numbers, symbols, words, sentences, voice, sound, music, any audibles, or any combination of, and still may contain visual element(s), picture(s), geometric object(s), painting(s), drawing(s), video(s), movie(s), clip(s), art(s), animation(s), or a combination of.

Certain embodiments of this disclosure provide a method generally including generating, creating, using, and/or re-using of the interpreted information are done manually, and/or autonomously, and/or automatically, and/or driven by, using, and/or through algorithms, scientific theories, concepts, methods and modalities, software and/or hardware and/or machine, or a combination of, and/or by and/or within computers, phones, any form of communication device, gadgets, wearable technologies, watches, glasses, sensors, actuators, processors, microprocessors, toys, vehicles, any devices and hardware, any software, appliances, any structures, tools, buildings, monitors, keyboards, mice, any parts of a system, human bodies, organic structures, inorganic structures, (please note, this list is not an exhaustive list of possible tools, structures, and applications).

Certain embodiments of this disclosure provide a method generally including providing the means to extract and translate the visual communication into written, and/or spoken, and/or machine language. This introduces ease of communication and provides diversity of communication choice and methods, based on usage scenario and user preference and need.

Certain embodiments of this disclosure provide a method generally including providing the means for rapid communications, hence saving time.

Certain embodiments of this disclosure provide a method generally including providing the means for rapid and selective choice of communications, hence saving lives in emergency situations.

Certain embodiments of this disclosure provide a method generally including providing the means for rapid and selective choice of communications, hence saving lives in situations, where attention needing handling of machinery is needed, such as in case of texting while driving.

Certain embodiments of this disclosure provide a method generally including providing the means for visual communications, for people with special needs, developmentally disabled or people with acquired disabilities and regenerative and/or brain damaging diseases, who generally convey their information better and easier through visual communications, and for whom, this visual communication is the only viable way of communications. The information conveyed in this visual communication is extracted and interpreted for people on the receiving end.

Certain embodiments of this disclosure provide a method generally including providing the means for blind people to be able to visually communicate.

Certain embodiments of this disclosure provide a method generally including providing the means for machines to be able to visually communicate with, and/or between, and/or among each other. This may enhance the application-to-Application(A2A), Application-to-People (A2P), People-to-Application (P2A), and/or device to device, and/or system-to-system, and/or organic structure-to-structure, and/or in-organic structure-to-structure, (please note, this list is not an exhaustive list of possible machines, structures, and applications), communication.

Certain embodiments of this disclosure provide a method generally including providing the means to eliminate the language barrier in international and global communications. Visual communication may be interpreted, and the conveyed information may be extracted and translated into spoken and/or written language manually, and/or automatically, and/or autonomously. People of different regions, countries, cultures, spoken languages and dialects may communicate with each other effortlessly using this visual communication interpreter.

### BRIEF DESCRIPTION OF THE DRAWINGS

A more particular description of the disclosure, briefly summarized above, can be had by reference to the embodiments of this disclosure, some of which are illustrated as examples of drawings, so that the recited features of the present disclosure can be understood in more detail. Please note, however, that the appended drawings are only examples and illustrate typical embodiments of this disclosure and therefore in no way limiting of its scope and diversity of ways to create and illustrate these embodiments. The disclosure may admit to other equally effective embodiments.

FIG. 1 illustrates an example of the proposed interpreting and extracting conveyed information in visual communications from visual communication unit(s) into written language, in accordance with certain embodiments of the present disclosure. The information to be conveyed by the visual elements in this visual communication unit is interpreted and translated into the following information: “I need Help! Please call Emergency/Medics.”

FIG. 2 illustrates an example of the proposed interpreting and extracting conveyed information in visual communications from visual communication unit(s) into written language, in accordance with certain embodiments of the present disclosure. The information to be conveyed by the visual elements in this visual communication unit is interpreted and translated into the following information: “On the Way Home!”

FIG. 3 illustrates an example of the proposed interpreting and extracting conveyed information in visual communications from visual communication unit(s) into written language, in accordance with certain embodiments of the present disclosure. The information to be conveyed by the visual elements in this visual communication unit is interpreted and translated into the following information: “There is a Robbery! Call the Police!”

FIG. 4 illustrates an example of the proposed interpreting and extracting conveyed information in visual communications from visual communication unit(s) into written language, in accordance with certain embodiments of the present disclosure. The information to be conveyed by the visual elements in this visual communication unit is interpreted and translated into the following information: “I am at the Hospital!”

FIG. 5 illustrates an example of the proposed interpreting and extracting conveyed information in visual communications from visual communication unit(s) into written language, in accordance with certain embodiments of the present disclosure. The information to be conveyed by the visual elements in this visual communication unit is interpreted and translated into the following information: “Staying after school for band/music!”

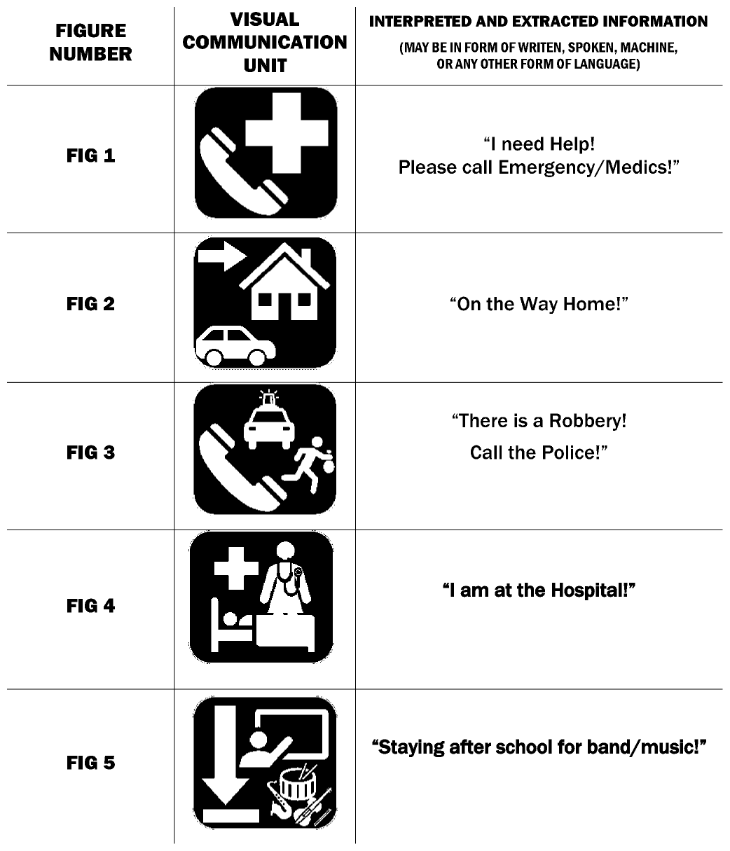

### DETAILED DESCRIPTION AND USE CASES

### Detailed Description

Embodiments of the present disclosure may interpret and extract the conveyed information in visual communications, from visual communication unit(s) into spoken, and/or written and/or machine language. Certain embodiments may do this by interpreting, extracting and translating the information conveyed in the visual element(s), picture(s), geometric object(s), painting(s), drawing(s), video(s), movie(s), clip(s), art(s), animation(s), or a combination of, in visual communication unit(s), into spoken, and/or written, and/or machine language. Then, may be communicating the interpreted information through the communication channel(s), tool(s), format(s), and medium/media of choice.

In certain embodiments of the present disclosure, the visual communication unit(s), and/or the information to be conveyed may be in lieu of or in conjunction with spoken, and/or written language, sign language, Braille language, bar code, or any machine language, any scripting language, alphabets, numbers, symbols, words, sentences, voice, sound, music, any audibles or any combination of.

Embodiments of the present disclosure may be communicated through the communication channel(s), tool(s), format(s), and medium/media of choice, such as email, instant messaging, texting, facetime, mobile, cellular, satellite, landline, cable, phone, computers, networks, any form of communications, Artificial Intelligence and cyber tools, optical communications, or else (these are not an exhaustive list of available communication channels, tools and media).

Embodiments of the present disclosure may interpret, extract and translate the conveyed information manually, and/or by, and/or within computers, phones, any form of communication device, gadgets, wearable technologies, watches, glasses, sensors, actuators, processors, microprocessors, toys, vehicles, any devices and hardware, any software, appliances, any structures, tools, buildings, monitors, keyboards, mice, any parts of a system, human bodies, organic structures, inorganic structures, (please note, this list is not an exhaustive list of possible tools, structures, and applications).

Embodiments of the present disclosure may generate, create, use, and/or re-use the interpreted information, may use spoken, and/or written language, sign language, Braille language, bar code, or any machine language, any scripting language, alphabets, numbers, symbols, words, sentences, voice, sound, music, any audibles or any combination of, and still may contain visual element(s), picture(s), geometric object(s), painting(s), drawing(s), video(s), movie(s), clip(s), art(s), animation(s), or a combination of.

Embodiments of the present disclosure may interpret, extract and translate the conveyed information manually, and/or autonomously, and/or automatically, and/or driven by, using, and/or through algorithms, scientific theories, concepts, methods and modalities, software, and/or hardware, and/or machine, or a combination of, by, and/or within computers, phones, any form of communication device, gadgets, wearable technologies, watches, glasses, sensors, actuators, processors, microprocessors, toys, vehicles, any devices and hardware, any software, appliances, any structures, tools, buildings, monitors, keyboards, mice, any parts of a system, human bodies, organic structures, inorganic structures, (please note, this list is not an exhaustive list of possible tools, structures, and applications).

Embodiments of the present disclosure may generate, create, use, and/or re-use the interpreted information manually, and/or autonomously, and/or automatically, and/or driven by, and/or using, and/or through algorithms, scientific theories, concepts, methods and modalities, software, and/or hardware, and/or machine, or a combination of, may use spoken, and/or written language, sign language, Braille language, bar code, or any machine language, any scripting language, alphabets, numbers, symbols, words, sentences, voice, sound, music, any audibles, or any combination of, and still may contain visual element(s), picture(s), geometric object(s), painting(s), drawing(s), video(s), movie(s), clip(s), art(s), animation(s), or a combination of

Embodiments of the present disclosure may generate, create, use, and/or re-use the interpreted information manually, and/or autonomously, and/or automatically, and/or driven by, using, and/or through algorithms, scientific theories, concepts, methods and modalities, software and/or hardware and/or machine, or a combination of, and/or by and/or within computers, phones, any form of communication device, gadgets, wearable technologies, watches, glasses, sensors, actuators, processors, microprocessors, toys, vehicles, any devices and hardware, any software, appliances, any structures, tools, buildings, monitors, keyboards, mice, any parts of a system, human bodies, organic structures, inorganic structures, (please note, this list is not an exhaustive list of possible tools, structures, and applications).

### Use Cases

Embodiments of the present disclosure may allow fast communication to take place by providing the means to extract and translate the visual communication into written, and/or spoken, and/or machine language. This may introduce ease of communication and may provide diversity of communication choice and methods, based on usage scenario and user preference and need.

Daily communication and status update may consist of many repetitive sentences, that may be conveyed through one visual unit. Some communication may need more of these units to be used, depending on the particular embodiments of the present disclosure created and/or used. This/These unit(s) may be re-used as needed in the same re-occurring situations, fast and easily, conveying the same information in accordance with embodiments of the present disclosure.

The embodiments of the present disclosure may be used to save lives in emergency, alert systems, Personal Emergency Response Systems (PERS), and disaster recovery situations, where rapid and selective choice of communication are of utmost importance.

The embodiments of the present disclosure may be also used in applications and device communications with Application-to-People (A2P), People-to-Application (P2A), Application-to-Application (A2A), and/or device to device, and/or system-to-system, and/or organic structure-to-structure, and/or in-organic structure-to-structure, (please note, these are not an exhaustive list of machines, structures, and applications). It may be used for any status updates and customer relationship management, event planning and reminder communications. This fast and easy visual communication may benefit consumers and enterprises the same. Healthcare, doctors, educational, law enforcement, work force, field force, sales and marketing, transportation, logistics, finance, and global governments may benefit from this rapid method of visual communication.

The embodiments of the present disclosure may be also used in tools, structures, applications and device communications within, and/or between, and/or among human bodies, organic structures, inorganic structures, computers, phones, any form of communication device, gadgets, wearable technologies, watches, glasses, sensors, actuators, processors, microprocessors, toys, vehicles, any devices and hardware, any software, appliances, any structures, tools, buildings, monitors, keyboards, mice, any parts of a system (please note, this list is not an exhaustive list of possible tools, structures, and applications).

The embodiments of the present disclosure may eliminate the language barrier in international and global communications. Visual communication may be interpreted, and the conveyed information may be extracted and translated into spoken and/or written language. People of different regions, countries, cultures, spoken languages and dialects may communicate with each other effortlessly using this visual communication interpreter.

The embodiments of the present disclosure may provide the means for blind people to be able to visually communicate using this visual communication interpreter.

Please note, the above use cases are only examples of many and in no means limiting the scope of implementation of the embodiments of the present disclosure.

1. A method for interpreting and extracting by visual communications conveyed information from visual communication unit(s) into spoken and/or written and/or machine language comprising:
a. Interpreting, extracting and translating the information conveyed in the visual element(s), picture(s), geometric object(s), painting(s), drawing(s), video(s), movie(s), clip(s), art(s), animation(s), or a combination of, in visual communication unit(s), into spoken and/or written and/or machine language.
b. Communicating the interpreted information through the communication channel(s), tool(s), format(s), and medium/media of choice.

2. The method of claim 1 wherein the visual communication unit(s) and/or the information to be conveyed may be in lieu of or in conjunction with spoken and/or written language, sign language, Braille language, bar code, or any machine language, any scripting language, alphabets, numbers, symbols, words, sentences, voice, sound, music, any audibles or any combination of.

3. The method of claim 2 wherein the communicating step (b) of claim 1 is done through the communication channel(s), tool(s), format(s), and medium/media of choice, such as email, instant messaging, texting, facetime, mobile, cellular, satellite, landline, cable, phone, computers, networks, any form of communications, Artificial Intelligence and cyber tools, optical communications, or else (these are not an exhaustive list of available communication channels, tools and media).

4. The method of claim 3 wherein, in the step (a.) of claim 1, the interpreting, extracting and translating of the conveyed information are done manually, and/or by, and/or within computers, phones, any form of communication device, gadgets, wearable technologies, watches, glasses, sensors, actuators, processors, microprocessors, toys, vehicles, any devices and hardware, any software, appliances, any structures, tools, buildings, monitors, keyboards, mice, any parts of a system, human bodies, organic structures, inorganic structures, (please note, this list is not an exhaustive list of possible tools, structures, and applications).

5. The method of claim 4 wherein, in the step (a.) of claim 1, the generating, creating, using and/or re-using of the interpreted information are done using spoken and/or written language, sign language, Braille language, bar code, or any machine language, any scripting language, alphabets, numbers, symbols, words, sentences, voice, sound, music, any audibles or any combination of, and still may contain visual element(s), picture(s), geometric object(s), painting(s), drawing(s), video(s), movie(s), clip(s), art(s), animation(s), or a combination of.

6. The method of claim 5 wherein, in the step (a.) of claim 1, the generating, creating, using and/or re-using of the interpreted information are done manually, and/or by, and/or within computers, phones, any form of communication device, gadgets, wearable technologies, watches, glasses, sensors, actuators, processors, microprocessors, toys, vehicles, any devices and hardware, any software, appliances, any structures, tools, buildings, monitors, keyboards, mice, any parts of a system, human bodies, organic structures, inorganic structures, (please note, this list is not an exhaustive list of possible tools, structures, and applications).

7. The method of claim 6 wherein, in the step (a.) of claim 1, the interpreting, extracting and translating of the conveyed information are done manually, and/or autonomously, and/or automatically, and/or driven by, using, and/or through algorithms, scientific theories, concepts, methods and modalities, software and/or hardware and/or machine, or a combination of, and/or by and/or within computers, phones, any form of communication device, gadgets, wearable technologies, watches, glasses, sensors, actuators, processors, microprocessors, toys, vehicles, any devices and hardware, any software, appliances, any structures, tools, buildings, monitors, keyboards, mice, any parts of a system, human bodies, organic structures, inorganic structures, (please note, this list is not an exhaustive list of possible tools, structures, and applications).

8. The method of claim 7 wherein, in the step (a.) of claim 1, the generating, creating, using and/or re-using of the interpreted information are done autonomously, and/or automatically, and/or driven by, using, and/or through algorithms, scientific theories, concepts, methods and modalities, software, and/or hardware, and/or machine, or a combination of, using spoken and/or written language, sign language, Braille language, bar code, or any machine language, any scripting language, alphabets, numbers, symbols, words, sentences, voice, sound, music, any audibles or any combination of, and still may contain visual element(s), picture(s), geometric object(s), painting(s), drawing(s), video(s), movie(s), clip(s), art(s), animation(s), or a combination of.

9. The method of claim 8 wherein, in the step (a.) of claim 1, the generating, creating, using and/or re-using of the interpreted information are done manually, and/or autonomously, and/or automatically, and/or driven by, using, and/or through algorithms, scientific theories, concepts, methods and modalities, software and/or hardware and/or machine, or a combination of, and/or by, and/or within computers, phones, any form of communication device, gadgets, wearable technologies, watches, glasses, sensors, actuators, processors, microprocessors, toys, vehicles, any devices and hardware, any software, appliances, any structures, tools, buildings, monitors, keyboards, mice, any parts of a system, human bodies, organic structures, inorganic structures, (please note, this list is not an exhaustive list of possible tools, structures, and applications).

10. The method of claim 9 wherein, the interpreting, extracting and translating of the conveyed information are done manually, and/or autonomously, and/or automatically, and/or driven by, using, and/or through algorithms, scientific theories, concepts, methods and modalities, software and/or hardware and/or machine, or a combination of, into any machine and/or programming, and/or scripting language, which can be understood and used for Application-to-Application(A2A), Application-to-People (A2P), People-to-Application (P2A), and/or device to device, and/or system-to-system, and/or oragic structure-to-structure, and/or in-organic structure-to-structure, (please note, this list is not an exhaustive list of possible machines, structures, and applications), communication.
